(19) United States
(12) Patent Application Publication
(10) Pub. No.: US 2008/0177629 A1
(43) Pub. Date: Jul. 24, 2008

(54) Off-road vehicle course associated with commercial complex

(76) Inventor: Roy Higgs, Severna Park, MD (US)

Correspondence Address: Patent Office of J. John Shimazaki, PLLC, P.O. Box 650741, Sterling, VA, 20165, US

(21) Appl. No.: 12/008,933

(22) Filed: Jan. 15, 2008

Related U.S. Application Data
(63) Continuation-in-part of application No. 10/715,268, filed on Nov. 17, 2003, now abandoned.
(60) Provisional application No. 60/426,380, filed on Nov. 15, 2002.

(51) Int. Cl. G06Q 99/00

(52) U.S. Cl. 705/14; 705/1

(57) ABSTRACT

The invention relates to an off-road vehicle course associated with a commercial complex, such as a traditional shopping center including retail shopping malls, wherein customers can drive sample off-road vehicles in the off-road conditions that the vehicles are designed for as a means of entertainment. The course can wind through the parking lot and/or common walkway area, and be provided with protective walls on either side, as well as be made below the surface level of the walkway area, and provided with pedestrian bridges, which can improve safety to onlookers. The present invention contemplates using an off-road vehicle course as a means of providing recreational entertainment to attract patrons to that commercial complex, as well as allowing patrons to drive their own cars on the course for a fee.

### RELATED APPLICATION

This application is a continuation in part and claims the benefit of the filing date of U.S. application Ser. No. 10/715,268, filed on Nov. 17, 2003, and U.S. Provisional Application Ser. No. 60/426,380, filed on Nov. 15, 2002.

### FIELD OF THE INVENTION

The present invention relates to vehicle courses, and in particular, an off-road vehicle course operated in association with a commercial complex.

### BACKGROUND OF THE INVENTION

During the last decade, sports utility vehicles (“SUV”) and four-wheel drives (often termed “4×4's”) have increased in popularity. These “off-roads vehicles typically offer advantages not provided by sedans and other smaller vehicles. SUV's and most 4×4's typically provide extra interior room for passengers and carrying capacity. They are also typically designed with sturdier suspension systems and have greater ground clearance for better performance and safety in off-road conditions. They are also often larger and heavier so that they stand up better in performance crash tests.

Manufacturers of off-road vehicles often tout how well their automobiles handle and perform in off-road conditions, such as in television commercials and the like. For example, many TV commercials show off-road vehicles traveling on rough terrain, wherein the message that is being conveyed to consumers is how well these vehicles handle, perform and stand up to the most difficult of off-road conditions.

Yet, vehicle dealerships that sell off-road vehicles typically only allow consumers to test-drive their vehicles on paved roads and streets, not on off-road terrain. Most consumers that are looking to buy off-road vehicles, therefore, never get the chance to test-drive those vehicles under the conditions that they were supposedly designed for. Accordingly, most consumers end up making purchase decisions without having had a chance to test drive the vehicles in off-road conditions, i.e., to determine whether the advertising claims are true.

Also, a significant percentage of people in this country who buy off-road vehicles live in suburban areas where there are few opportunities to drive them off-road. Other than a few sparse areas, there are typically no designated off-road areas or courses available where vehicle owners can take their vehicles off-road for recreational purposes. In many cases, locations where they can be driven off-road are hundreds of miles away, making it inconvenient and impractical to do so.

### SUMMARY OF THE INVENTION

The present invention relates to an off-road vehicle course associated with a commercial complex, such as a vehicle dealership or shopping center, which overcomes the disadvantages discussed above.

When associated with a vehicle dealership, the present invention contemplates an off-road vehicle course that is operated in conjunction with the dealership. The course, in such case, can be located on, adjacent or near the dealership, and is preferably operated by, or under the direction of, the dealership. This way, consumers will be able to test drive the off-road vehicles that they are interested in buying before making their purchase decisions, in the off-road conditions that the vehicles are designed for.

The course itself can be created with a variety of different terrains arid obstacles specially designed for off-road vehicles. For example, the course can be made using dirt, gravel, sand, rocks, grass, water, etc., and can have hills, slopes, inclines, declines, mounds, pits, bumps, etc., as well as ditches, ravines, bridges, trees, bushes, fences, walls, potholes, etc. These terrains and obstacles can be arranged in any manner that creates an effective and entertaining course for test-driving purposes. The course can also be as long or short as needed, and can have several different paths, if desired, so that more than one vehicle can be on the course at any given time without the risk of accident.

Various methods of operating the course are contemplated. For example, the dealership can allow customers the opportunity to test-drive new cars for free based on a judgment of how serious the customer might be. Likewise, the dealership can charge a fee to each person that uses the course, wherein it can also reimburse the customer if and when a vehicle is purchased from that dealership, as a means of giving an incentive. The dealership could also allow customers to compare their old vehicles with the new ones that they sell, by allowing customers to drive their own off-road vehicles, as well as the new ones, which can help customers fully appreciate the differences between them.

When a group of dealerships is involved, the dealerships preferably enter into an agreement to have an off-road course developed and/or operated jointly. Dealerships are often clustered together in a geographical area, such as due to restrictive zoning laws. In such case, the off-road course could be located on, adjacent or near one or more of the dealerships in the group. The course can also be operated by one of the dealerships, a designated independent operator, or jointly by the group or more than one dealership, etc. In such case, each dealership in the group could contribute to the up-front cost of developing the course, as well as the cost of maintaining and operating the course, and in return, each dealership could be allowed to use the course, i.e., allow their customers to test-drive their vehicles on the course. The dealerships could also jointly contribute to the cost of marketing, advertising, etc.

The present invention also contemplates a business method wherein the dealership or dealerships can promote the off-road vehicle course as a means of attracting customers to the dealership(s). For example, when a single dealership is involved, the off-road vehicle course could be developed to draw attention to that dealership, and when a group of dealerships is involved, the entire group could use the course to attract customers to that location, and away from other locations, where other dealerships may be located. Being the only dealership or group of dealerships in that geographical area that can offer the advantages of having an off-road test course that customers can drive on can make it more likely that consumers wilt go to that location.

The present invention also contemplates using an off-road vehicle course as a means of providing recreational entertainment to attract patrons to a commercial complex, such as a traditional shopping center, including standard retail malls and outlet malls having standard non-automobile related establishments, such as clothing stores, restaurants, sporting goods stores, shoe stores, etc. Many shopping malls, especially in rural and suburban areas, including many outlet malls, are located on wide-open spaces, such as near farms, highways and industrial/commercial areas. These conditions make it commercially feasible and possible for land to be purchased or leased at a relatively affordable rate, and for an off-road vehicle course to be developed and operated in conjunction therewith.

The course could also be designed to provide recreational off-road entertainment for off-road vehicle owners and enthusiasts, which can have the effect of attracting patrons to the shopping center. For example, the off-road course can be operated on or adjacent the shopping center property, which may not only help draw attention to the shopping center, but can also provide a source of entertainment and recreation for shopping center patrons. The course can also have a few rental vehicles on hand, and/or allow people with their own off-road vehicles to drive on the course, i.e., for a fee.

Operation of the course could also be coordinated so that discounts and incentives can be provided that can help promote retail establishments located at the shopping center, while at the same time, promoting the course. For example, a discount can be given to patrons of a retail establishment whenever a patron pays the fee and uses the course. Likewise, whenever a patron buys a certain minimum quantity at a retail establishment, a discount can be given on the fees to use the course.

The present invention also contemplates using the vehicle course in conjunction with both a vehicle dealership and shopping center, wherein the course can be used to promote not only the cars that are being sold at the dealership, but also the shopping center and its retail establishments, which can be located adjacent or near the dealership.

When the course is located at a shopping center, such as a retail mall, the course can be designed to cut through the parking lot and/or common walkway area, wherein a lower level path can be developed, which would not involve any risks to spectators, wherein the path could be made with concrete walls, and have a floor of dirt, gravel, sand, rocks, etc. The path could wind around the parking lot and possibly go through a portion of the shopping center, i.e., in another low-level path, with pedestrian bridges overhead. The path could also extend out into an open area where there could be hills, slopes, inclines, etc. Again, the course can be as long or short as needed, and can have several different paths.

### BRIEF DESCRIPTION OF THE DRAWINGS

FIG. 1 shows an off-road vehicle course operated in association with a vehicle dealership;

FIG. 2 shows an off-road vehicle course operated in association with a traditional indoor shopping center having a vehicle dealership located therein;

FIG. 3 shows a cross section of the off-road vehicle course operated in association with a shopping center that is extended below the level of the common walkway area, and has side walls and a pedestrian walkway overhead; and

FIG. 4 shows an off-road vehicle course operated in association with a traditional outdoor shopping center wherein the shopping center has no automobile related establishments located therein.

### DETAILED DESCRIPTION OF THE INVENTION

### 1. Vehicle Dealership:

Vehicle dealerships are like any other business in that they need business income to operate. The main source of income, in such case, comes from automobile sales. While a particular consumer's interest in a particular dealership will usually come from the interest that he or she has in the cars that the dealership sells, there is usually great competition among sellers of cars. This is true with respect to dealerships that sell competing brand named cars, such as Chevrolet, Ford, Honda and Toyota, but this is also true with respect to dealerships that sell the same brand named cars. For example, while there is obviously great competition between Chevrolet and Ford, and between Honda and Toyota, etc., there can also be great competition among dealerships within those same organizations, i.e., between different Chevrolet dealerships, between different Honda dealerships, between different Ford dealerships, and between different Toyota dealerships, etc., each vying for a share of the business.

Various promotional offers, including sales and discounts, can be offered by dealerships to attract customers to their stores. Advertisements on television, radio and newspapers, etc., are commonly used for this purpose. Various marketing techniques, including offering better financing terms on loans, lower down payments, rebates, free options, higher prices on trade-ins, etc., are often employed. Dealerships also typically pay commissions to sales agents to give them incentives to sell more cars.

While many dealerships sell certain makes of cars, some of the most popular cars on the market today are SUV's and 4×4's. Names like Jeep Cherokee, Ford Expedition, Honda CRV, Toyota Forerunner, are commonplace. For this reason, dealerships that carry brand named automobiles inevitably carry a number of SUV and 4×4 models, which are extremely popular.

The present invention relates to a method wherein an off-road vehicle course can be used in conjunction with a vehicle dealership which can also be located in a shopping center. The dealership embodiment allows customers to test-drive the off-road vehicles that they are interested in, under the conditions that the vehicles were designed for. This way, consumers that are looking to buy a particular off-road vehicle will have an opportunity to test-drive that vehicle, as well as others, in the off-road conditions that the vehicles were designed for, before making a purchase decision.

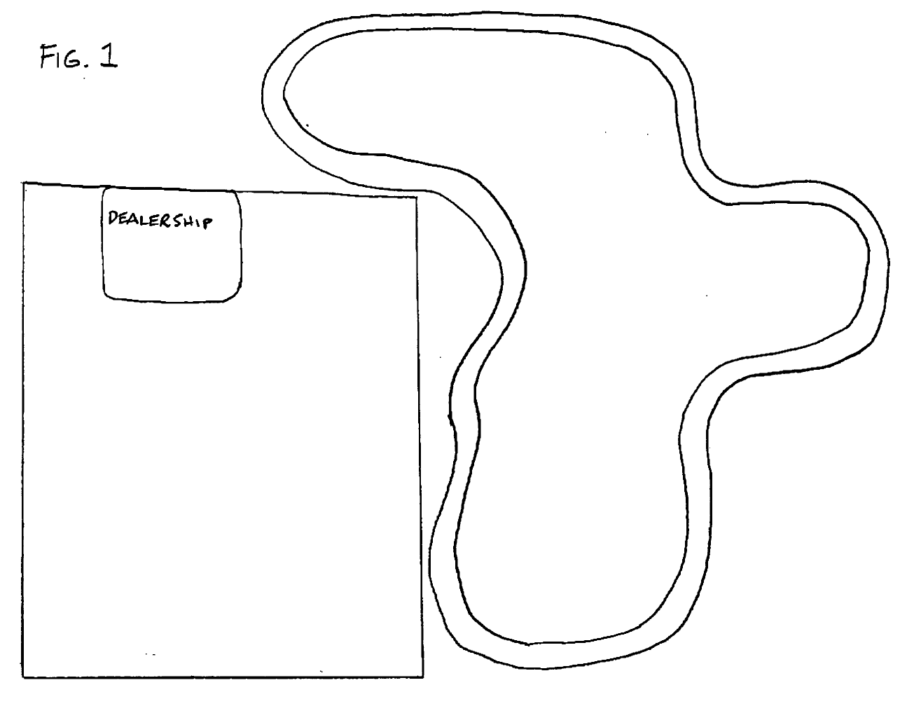

When associated with a single vehicle dealership, as shown in FIG. 1, the present invention contemplates that the course can be located on, adjacent or near the dealership's property. The dealership can, for example, convert some of its existing land into an off-road course, or, it can purchase extra land adjacent or nearby the dealership.

The course itself can have a variety of different terrains and obstacles. For example, the course can be made using dirt, gravel, sand, rocks, grass, water, etc. It can have hills, slopes, inclines, declines, mounds, pits, bumps, etc., as welt as obstacles, including ditches, ravines, bridges, trees, bushes, fences, walls, potholes, etc. The terrains and obstacles can be arranged in any manner that creates an effective and entertaining course for test-driving purposes. The course can also be as long or short as needed, and can have several different paths, if desired, so that more than one vehicle can be on the course at any given time, without the risk of accident.

Various methods of operating the course are contemplated. For example, the course can be operated by the vehicle dealership, or by another entity under the direction of the vehicle dealership. It can also be operated for free, based on a judgment of how serious the customer might be in buying the vehicle at that time, or, the dealership can charge a fee to each driver that uses the course, i.e., the course could be a profit-making operation, wherein drivers could be allowed to drive their own vehicles on the course, if desired. The dealership could also reimburse customers for using the course if and when a vehicle is purchased from that dealership, which would not only give the customer an incentive to come to the dealership, but also an incentive to purchase a vehicle there. Discounts on the purchase price of a vehicle when the vehicle course is used can also be provided.

Customers can be allowed to test drive their own off-road vehicles, as well as the new ones, to help customers compare the vehicles and appreciate the differences between them. In such case, the dealership could show the customer how much better the new vehicles are compared to the older vehicles.

The dealership can also dedicate certain off-road vehicles for test-driving purposes, so that not all vehicles offered for sale are available for test-driving. For example, certain vehicles can be set aside specifically for test-driving purposes, which may be advantageous due to the fact that the test driven vehicles are likely to need extra maintenance, care, and cleaning, to ensure that they are kept in good condition. Like rental cars, once the test driven cars are used and driven on the course, they may only be capable of being sold as used cars, i.e., at used car prices. The new vehicles that are offered for sale, on the other hand, can be kept new and unused. A dealership may, nevertheless, at its own discretion, allow customers that are close to buying a vehicle the opportunity to test drive the particular vehicle that they want to buy, to enable them to see how that particular vehicle handles and performs on the course. In such case, the dealership may limit such use to only those situations where the customer has already test driven another dedicated vehicle, and is close to making or has already made a purchase decision. This way, the chances that someone might drive a brand new vehicle on the course, and end up not buying that vehicle, would be reduced.

The present invention contemplates a method wherein the dealership can advertise the off-road vehicle course as a means of attracting customers to the dealership. For example, the dealership can promote the course on television, radio, print advertisements, etc., as a means of increasing the likelihood that consumers will come to that dealership, instead of another, to test drive their vehicles.

In this respect, the present invention contemplates that in any given geographical area, a single off-road vehicle course could be made available so that a particular dealership would stand to benefit from making the course available to its customers. Being the only dealership in the area that has the course and makes it available to customers will enable it to use the course for promotional purposes and to attract customers to that location.

The dealership could also operate the course for corporate or group outings and functions, i.e., allow SUV and 4×4 enthusiasts the opportunity to drive on the course with their own vehicles. That is, the dealership could allow the course to be rented or used by a particular company or group for a limited engagement, wherein a fee could be charged for the use of the facility, i.e., they could charge by the hour. This could be a way for the dealership to not only earn additional revenue, but to indirectly promote the course and dealership to those who attend the outing or function, and drive on the course.

Other incentives can be given to attract customers to the dealership. Various discounts and incentives, for example, can be given for trying the course. The dealership can give customers who drive on the course certain discounts that can be used at contracted establishments, such as restaurants, clothing stores, grocery stores, etc., as an incentive for using the course and trying out their vehicles.

Preferably, the dealership will obtain insurance sufficient to cover potential liabilities that might arise from operating the course. The dealership can also require customers and other users of the course to sign waivers of liability for further protection.

Vehicle dealerships are often clustered together in a geographical area, such as due to restrictive zoning laws. In such case, a group of dealerships can develop, maintain and/or operate an off-road vehicle course jointly. They can, for example, enter into an agreement, whereby each dealership in the group could contribute to the up-front costs and efforts of developing the course, as well as the cost and effort of maintaining and operating the course, and in return, each dealership could be allowed to use the course, i.e., allow customers to test-drive their vehicles on the course. The dealerships can also jointly contribute to the cost and effort of marketing, advertising, etc., wherein the dealerships could use the course as a promotional tool to help attract customers to that location.

The off-road course can be located on, adjacent or near one or more of the dealerships in the group. The course can also be operated by one of the dealerships, a designated independent operator, or jointly by the group or more than one dealership, etc. Rather than having a single dealership be responsible for the entire cost and operation of the course, such responsibilities can be spread out between the dealerships, wherein the benefits can also be spread to group members.

The management of the course would have to take into account the interests of each dealership. For example, each dealership could make certain off road vehicles available at the course for test-driving purposes, wherein consumers would then be allowed to pick and choose which ones to test-drive. This would give consumers the opportunity to try out different makes and models of vehicles, wherein each dealership would be able to promote and give added exposure for its vehicles. In another embodiment, each dealership can be given access to the course during a specified time, so that at the appropriate time they can send interested drivers to the course with their vehicles to be test-driven. In such case, a scheduling system would be implemented to ensure that usage of the course is property allocated and prioritized between the dealerships. This can give each dealership the opportunity to control the use of the course during the scheduled time, wherein each one can then give particular attention to the customers that are interested in using the course to test their vehicles.

The present invention contemplates that the course could be used in connection with a business method wherein the dealership or group of dealerships can promote the off-road vehicle course as a means of attracting customers to the dealership(s). For example, when a single dealership is involved, the off-road vehicle course could be operated to draw attention to that dealership, and when a group of dealerships is involved, the entire group could use the course to attract customers to that location. The present invention contemplates that the vehicle course could be made available in any given metropolitan or geographical area, wherein the course could be used as a means of promoting the dealership, or group of dealerships, that operate in that area thereby increasing the chances that their customers would visit that location and/or buy a car from that location. Being the only dealership or group of dealerships in a geographical area that can offer the advantages of making an off-road test course available can make it more likely that customers will go to that location instead of another.

### 2. Shopping Center:

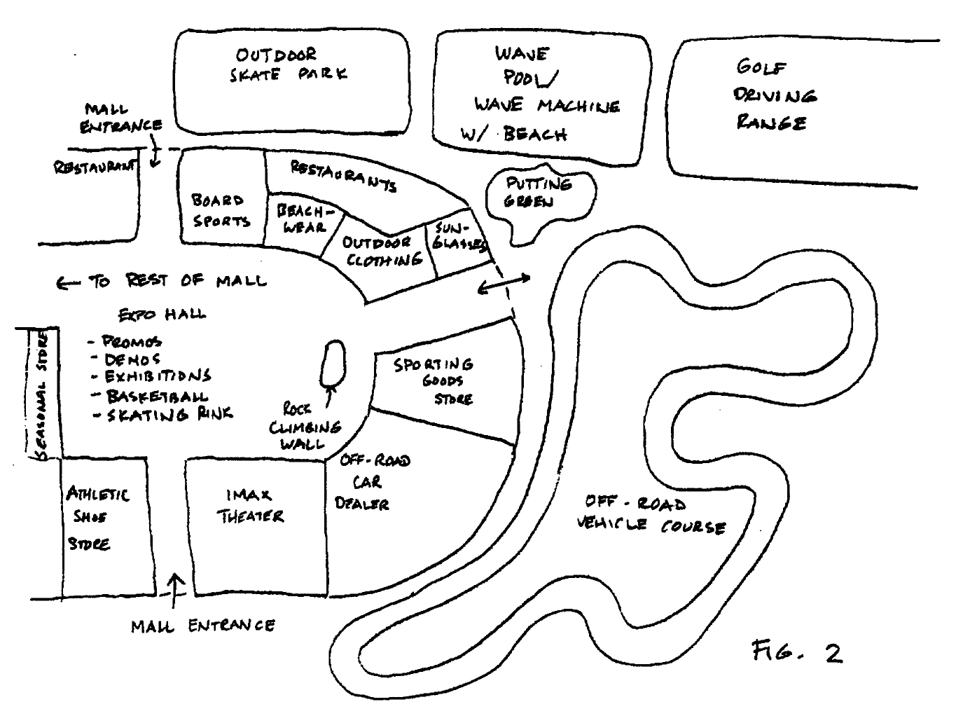

The present invention contemplates using an off-road vehicle course as a means of providing recreational entertainment to attract patrons to a commercial complex, such as a shopping center, including traditional retail shopping malls, as shown in FIGS. 2 and 4, and outlet malls. FIG. 2 shows a traditional indoor shopping mall with a vehicle dealership located therein, and FIG. 4 shows a traditional indoor/outdoor shopping mall without any automobile related establishments located therein. Both are shown with the vehicle course of the present invention incorporated therein. Many shopping malls, especially in rural and suburban areas, are located on large open tracts of land. Many outlet malls, for example, are located on wide-open spaces, such as near farms, highways and industrial/commercial areas. These conditions make it commercially feasible and possible for land to be purchased at a relatively affordable rate, and an off-road vehicle course to be developed and operated in conjunction therewith.

The course itself can be created in much the same manner as the course for the car dealership described above. In addition, it can be developed so that it is located on the shopping center property, and so that it is extended near or through the common walkway area, and/or near or through the shopping center parking lot, as shown in FIGS. 2 and 4. This way, patrons of the shopping center can become spectators, wherein they would be able to see the cars that are driving on the course, such as from the parking lot or shopping center walkways and pedestrian bridges, etc. This might be especially appropriate for a shopping center that has vehicle dealerships, automobile supply stores, repair shops, service stations, tire stores, etc., or other automobile related establishments, located at the shopping center, but can also be appropriate for traditional retail shopping malls that have no automobile related establishments of any kind. In fact, due to the popularity of traditional retail shopping malls, and the total number of such malls located throughout the country, it is contemplated that the preferred embodiment of the present invention is a traditional mall that does not have automobile related establishments located therein. Although some malls have automobile associated establishments nearby, such as a Sears Auto Center in a separate building in the parking lot next to the Sears department store, most traditional retail malls (such as those contemplated herein) do not physically have automobile related establishments located within the physical premises and space of the mall.

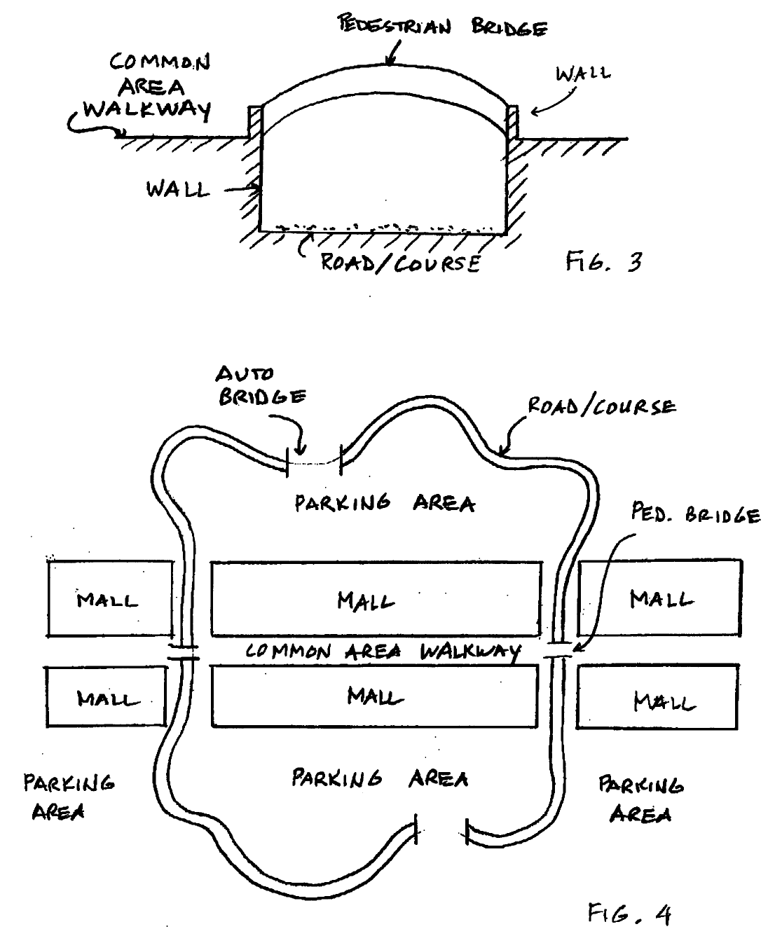

The course can cut through the parking lot, and then through the shopping center, such as shown in FIG. 4, wherein a lower level path could be developed, which would not involve any risks to spectators, wherein the path could be made with concrete walls on either side, and have a floor of dirt, gravel, sand, rocks, etc., as shown in FIG. 3. The path could then wind around the parking lot and possibly go through or near a portion of the common walkway area of the shopping center, i.e., in a low-level path, such as with a pedestrian bridge overhead as shown in FIG. 4. The path could also extend out into an open area where there could be hills, slopes, inclines, etc. Again, the course can be as long or short as needed, and can have several different paths.

The course could be designed to provide recreational off-road entertainment for off-road vehicle owners and enthusiasts, which can have the effect of attracting patrons to the shopping center. This could help draw attention to the shopping center, and provide a source of entertainment and recreation for shopping center patrons.

Operation of the course could also be coordinated so that discounts and incentives can be provided that help promote retail establishments located at the shopping center, while at the same time, promoting the course. For example, a discount to a retail establishment could be given whenever a patron pays for the use of the course. Likewise, whenever a patron makes a purchase, such as a particular item, or a minimum quantity, at one of the retail establishments, a discount to use the course can be given.

The course can have a few rental vehicles on hand, which can be rented for predetermined lengths of time, i.e., an hour, for a fee. The course could also allow people with their own off-road vehicles to drive on the course, i.e., for a fee.

The present invention also contemplates using the vehicle course in conjunction with both a vehicle dealership and shopping center, wherein the course can be used to promote not only the cars that are being sold at the dealership but also the shopping center and its retail establishments, which can be located adjacent or near the dealership.

What is claimed is:

1. A traditional retail shopping center or mall, comprising:
a plurality of retail establishments occupying space at said center or mall wherein said establishments are in businesses unrelated to automobiles;
a common walkway area extended through said center or mall on which customers of said center or mall may walk from one establishment to the next; and
an off-road vehicle course having off-road conditions upon which off-road vehicles can be driven, wherein said course is located on the property of said center or mall, and extends through or near said common walkway area, and/or through or near a parking lot associated with said center or mall.

2. The center or mall of claim 1, wherein said course comprises a road that extends through or near at least a portion of said common walkway area, wherein at least a portion of said course has protective walls to prevent injury to customers that may be walking along said common walkway area.

3. The center or mall of claim 2, wherein said portion of said course that extends through said common walkway area is extended below the surface of said common walkway area adjacent said course, and wherein said walls are extended upward on either side of said road to provide viewing areas that allow customers of said center or mall to view vehicles traveling on said course.

4. The center or mall of claim 2, wherein said portion of said course that extends through said common walkway area is provided with a pedestrian bridge that extends over at least a portion of said course to enable customers of said center or mall to view vehicles traveling on said course from said bridge.

5. The center or mall of claim 1, wherein the center or mall provides off-road vehicles customers of said center or mall can rent for a limited time and drive on said course.

6. The center or mall of claim 1, wherein the center or mall allows customers of said center or mall to drive their own vehicles on said course for a fee.

7. The center or mall of claim 1, wherein the center or mall provides discounts on fees for using the course, based on purchases made by customers at one or more of said retail establishments at said center or mall.

8. The center or mall of claim 1, wherein paying a fee for using the course entitles customers of said center or mall to at least one discount or other incentive at one or more of said retail establishments located at said center or mall.

9. The center or mall of claim 1, wherein in addition to said retail establishments, the center or mall has other establishments having businesses relating to automobiles such as a car dealership.

10. A traditional retail shopping center or mall, comprising:
a plurality of retail establishments occupying space at said center or mall wherein said establishments are in businesses unrelated to automobiles;
a common walkway area extended through said center or mall on which customers of said center or mall may walk from one establishment to the next;
an off-road vehicle course having off-road conditions upon which off-road vehicles can be driven, wherein at least a portion of said course comprises a road extended below the surface level of said common walkway area, adjacent said course, and wherein protective walls are extended upward on either side of said road to allow customers on said common walkway area to view vehicles traveling on said course from said common walkway area.

11. The center or mall of claim 10, wherein at least a portion of said course extends through at least a portion of a parking lot associated with said center or mall.

12. The center of mall of claim 10, wherein at least a portion of said course extends through or across said common walkway area of said center or mall.

13. The center or mall of claim 12, wherein said portion of said course that extends through or across said common walkway area is provided with a pedestrian bridge that extends over at least a portion of said course to enable customers of said center or mall to view vehicles traveling on said course from said bridge.

14. The center or mall of claim 10, wherein the center or mall provides off-road vehicles customers of said center or mall can rent for a limited time and drive on said course.

15. The center or mall of claim 10, wherein the center or mall allows customers of said center or mall to drive their own vehicles on said course for a fee.

16. The center or mall of claim 10, wherein the center or mall provides discounts on fees for using the course, based on purchases made by customers at one or more of said retail establishments at said center or mall.

17. The center or mall of claim 10, wherein paying a fee for using the course entitles customers of said center or mall to at least one discount or other incentive at one or more of said retail establishments located at said center or mall.

18. The center or mall of claim 10, wherein in addition to said retail establishments, the center or mall has other establishments having businesses relating to automobiles.

19. The center or mall of claim 18, wherein said other establishments include a car dealership.
